(19) United States
(12) Patent Application Publication
(10) Pub. No.: US 2007/0018593 A1
(43) Pub. Date: Jan. 25, 2007

(54) Balanced current lamp module and multi-lamp circuit

(75) Inventor: Chun-Liang Kuo, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS INC.

(21) Appl. No.: 11/488,016

(22) Filed: Jul. 18, 2006

(30) Foreign Application Priority Data
Jul. 22, 2005 (TW) 094124963

(51) Int. Cl. H05B 39/00

(52) U.S. Cl. 315/312

(57) ABSTRACT

A balanced current lamp module driven by a power source includes a first balanced current unit, a second balanced current unit and a balanced transformer. The first balanced current unit includes a first transformer, a first lamp and a second lamp. The first transformer has one coil electrically connected with the power source, and the other coil having two ends respectively electrically connected with the first lamp and the second lamp. The second balanced current unit includes a second transformer, a third lamp and a fourth lamp. The second transformer has one coil electrically connected with the power source, and the other coil having two ends respectively electrically connected with the third lamp and the fourth lamp. The balanced transformer has one coil electrically connected with the first lamp, and the other coil electrically connected with the fourth lamp.

### BACKGROUND OF TH INVENTION

1. Field of Invention

The present invention relates to a lamp module and a multi-lamp circuit, and more particularly, to a balanced current lamp module and a multi-lamp circuit.

2. Related Art

Because a cold cathode fluorescent lamp (CCFL) has a high luminance, the CCFL can serve as a light source and be applied to an electronic device, such as a liquid crystal display, to serve as a backlight source.

FIG. 1 is a schematic view showing a driving circuit for a conventional balanced current lamp circuit. As shown in FIG. 1, a power source 11 is electrically connected with a coil 121 of a transformer 12, and two lamps 14 and 16 are respectively electrically connected with the other coil 122 of the transformer 12 through two capacitors 13 and 15. However, this connection method cannot ensure the working currents of the lamps 14 and 16 to be the same, and the luminance of the lamps 14 and 16 is thus different from each other.

Furthermore, FIG. 2 is a schematic view showing another driving circuit with an added balanced transformer. As shown in FIG. 2, a power source 21 is electrically connected with a coil 221 of a transformer 22. Two lamps 24 and 26 are respectively electrically connected with the other coil 222 of the transformer 22 through two capacitors 23 and 25. The lamps 24 and 26 are also electrically connected with two coils 271 and 272 of a balanced transformer 27, such that the working currents of the lamps 24 and 26 are adjusted and unified through the balanced transformer 27.

In addition, a feedback circuit 28 may also be connected with the coil 271 of the balanced transformer 27 so as to control the power source 21 in a feedback manner according to the working current of the lamp 24 and thus to adjust the working currents of the lamps 24 and 26.

Although this connection method can ensure the lamps 24 and 26 to have the same working current, the amount of balanced transformers has to be increased when the amount of lamps is increased because two lamps need one balanced transformer to ensure the working currents of the lamps to be the same. Thus, the cost is increased and the high cost is disadvantageous to the manufacture if the lamps are ensured to have the same luminance.

It is thus imperative to provide a balanced current lamp module and a multi-lamp circuit, which can control and unify the working currents of the lamps, such that the lamps can be held at the same luminance, and the amount and cost of the balanced transformers can be decreased.

### SUMMARY OF THE INVENTION

In view of the foregoing, the present invention provides a balanced current lamp module and multi-lamp circuit, which can decrease the amount of the balanced transformers and ensure each lamp to have the same luminance.

To achieve the above, a balanced current lamp module according to the present invention is driven by a power source. The balanced current lamp module includes a first balanced current unit, a second balanced current unit and a balanced transformer. The first balanced current unit includes a first transformer, a first lamp and a second lamp. The first transformer has one coil electrically connected with the power source and the other coil having two ends respectively electrically connected with the first lamp and the second lamp. The second balanced current unit includes a second transformer, a third lamp and a fourth lamp. The second transformer has one coil electrically connected with the power source, and the other coil having two ends respectively electrically connected with the third lamp and the fourth lamp. The balanced transformer has one coil electrically connected with the first lamp, and the other coil electrically connected with the fourth lamp.

To achieve the above, a multi-lamp circuit according to the present invention is electrically connected with a power source. The multi-lamp circuit includes a plurality of balanced current lamp modules. Each balanced current lamp module includes a first transformer, a second transformer, a first lamp, a second lamp, a third lamp, a fourth lamp and a balanced transformer. One coil of the first transformer and one coil of the second transformer are electrically connected with the power source. Two ends of the other coil of the first transformer are respectively electrically connected with the first lamp and the second lamp. Two ends of the other coil of the second transformer are respectively electrically connected with the third lamp and the fourth lamp. One coil of the balanced transformer is electrically connected with the first lamp, and the other coil of the balanced transformer is electrically connected with the fourth lamp.

To achieve the above, another multi-lamp circuit according to the present invention is electrically connected with a power source. The multi-lamp circuit includes a plurality of balanced current lamp modules and a plurality of sub-stage balanced transformers. Each balanced current lamp module includes a first transformer, a second transformer, a first lamp, a second lamp, a third lamp, a fourth lamp and a balanced transformer. One coil of the first transformer and one coil of the second transformer are electrically connected with the power source. Two ends of the other coil of the first transformer are respectively electrically connected with the first lamp and the second lamp. Two ends of the other coil of the second transformer are respectively electrically connected with the third lamp and the fourth lamp. The balanced transformer has one coil electrically connected with the first lamp, and the other coil electrically connected with the fourth lamp. The sub-1-stage balanced transformer is electrically connected with two of the balanced current lamp modules, and the sub-N-stage balanced transformer is electrically connected with two of the sub-(N−1)-stage balanced transformers.

As mentioned above, due to two ends of the other coil of the first transformer are respectively electrically connected with the first lamp and the second lamp, two ends of the other coil of the second transformer are respectively electrically connected with the third lamp and the fourth lamp, one coil of the balanced transformer is electrically connected with the first lamp, and the other coil of the balanced transformer is electrically connected with the fourth lamp, the working currents of each lamp are the same. Comparing with the prior art, a balanced current lamp module and a multi-lamp circuit according to the present invention can decrease the amount and cost of the balanced transformers, and ensure each lamp to have the same luminance.

### BRIEF DESCRIPTION OF THE DRAWINGS

The present invention will become more fully understood from the detailed description given herein below illustration only, and thus are not limitative of the present invention, and wherein:

FIG. 1 is a schematic view showing a conventional balanced current lamp circuit;

FIG. 2 is a schematic view showing another conventional balanced current lamp circuit;

FIG. 3 is a schematic view showing a balanced current lamp module according to a preferred embodiment of the present invention; and

FIG. 4 is a schematic view showing a multi-lamp circuit according to a preferred embodiment of the present invention.

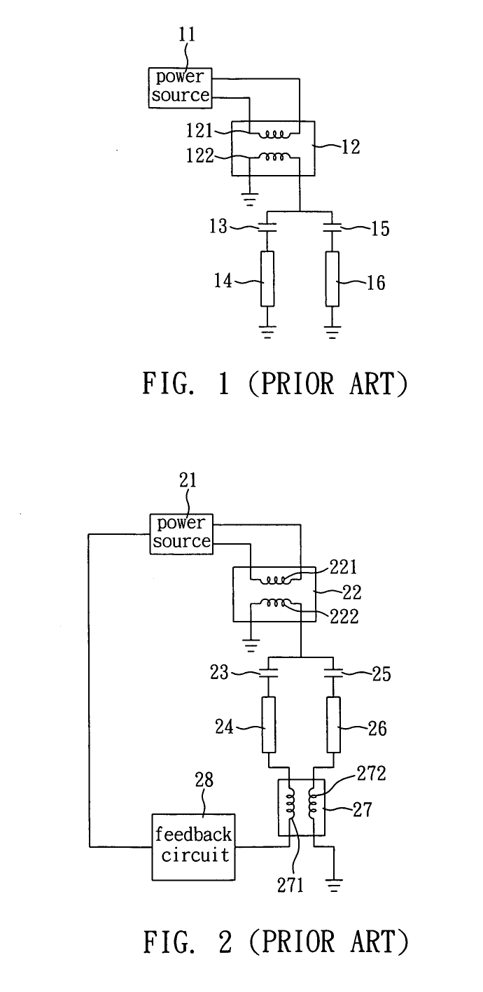

### DETAILED DESCRIPTION OF THE INVENTION

The present invention will be apparent from the following detailed description, which proceeds with reference to the accompanying drawings, wherein the same references relate to the same elements.

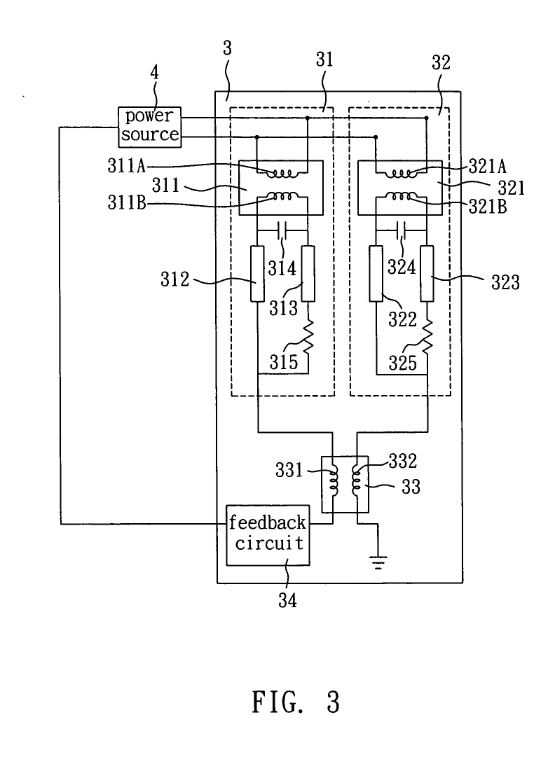

As shown in FIG. 3, a balanced current lamp module 3 according to a preferred embodiment of the present invention, which is driven by a power source 4, includes a balanced current unit 31, a balanced current unit 32 and a balanced transformer 33.

The balanced current unit 31 includes a transformer 311, a lamp 312 and a lamp 313. The transformer 311 has one coil 311A electrically connected with the power source 4, and the other coil 311B having two ends respectively electrically connected with the lamp 312 and the lamp 313.

The balanced current unit 32 includes a transformer 321, a lamp 322 and a lamp 323. The transformer 321 has one coil 321A electrically connected with the power source 4, and the other coil 321B having two ends respectively electrically connected with the lamp 322 and the lamp 323.

The balanced transformer 33 has one coil 331 electrically connected with the lamp 312, and the other coil 332 electrically connected with the lamp 323. In this embodiment, the coil 331 of the balanced transformer 33 is electrically connected with a feedback circuit 34, and each of the lamps 312, 313, 322 and 323 may be a cold cathode fluorescent lamp.

In addition, the balanced current unit 31 further includes a capacitor 314 and a resistor 315. The capacitor 314 is connected in parallel with the coil 311B of the transformer 311 and connected between the lamps 312 and 313. The resistor 315 is connected with the lamp 313 in series. The resistor 315 may be a fixed resistor, a positive temperature thermistor or a negative temperature thermistor.

The balanced current unit 32 further includes a capacitor 324 and a resistor 325. The capacitor 324 is connected in parallel with the coil 321B of the transformer 321 and connected between the lamps 322 and 323. The resistor 325 is connected with the lamp 323 in series. The resistor 325 may be a fixed resistor, a positive temperature thermistor or a negative temperature thermistor.

The feedback circuit 34, which is electrically connected with the coil 331 of the balanced transformer 33, controls the power source 4 in a feedback manner according to working currents of the lamps 312 and 313, and thus adjusts the working currents of the lamps 312, 313, 322 and 323.

In this embodiment, one balanced transformer can balance the working currents of four lamps. Comparing with the prior art, the amount and cost of the balanced transformers of the present invention can be reduced, so each lamp can be ensured to have the same luminance.

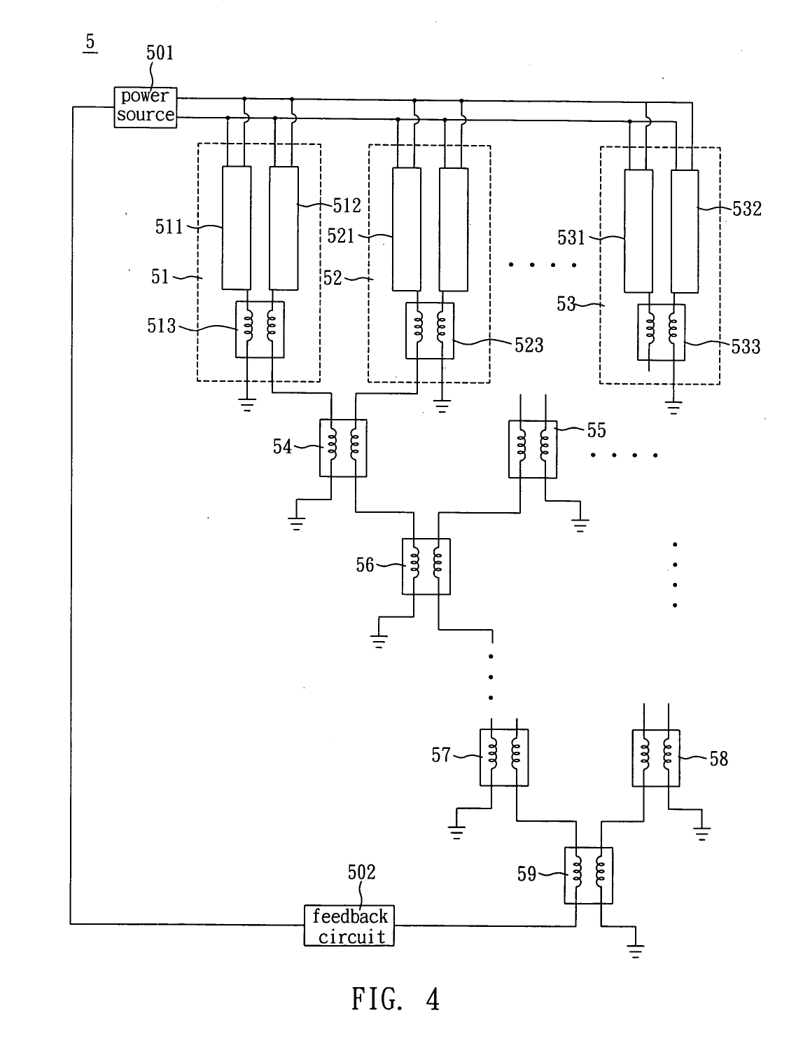

As shown in FIG. 4, a multi-lamp circuit 5 according to a preferred embodiment of the present invention, which is electrically connected with a power source 501, includes a plurality of balanced current lamp modules 51 to 53.

Each of the balanced current lamp modules 51 to 53 includes a plurality of balanced current units. For example, the balanced current lamp module 51 includes a balanced current unit 511, a balanced current unit 512 and a balanced transformer 513. For example, the balanced current unit 511 may include a transformer, two lamps, a capacitor and a resistor (not shown). The balanced current units 511, 512, 521, 522, 531 and 532 and the balanced transformers 513, 523 and 533 of FIG. 4 respectively have the same constructions and functions as those of the balanced current unit 31, the balanced current unit 32 and the balanced transformer 33 of the embodiment shown in FIG. 3. So, detailed descriptions thereof will be omitted.

In addition, the multi-lamp circuit 5 further includes a plurality of sub-stage balanced transformers 54 to 59. The sub-1-stage balanced transformer 54 is electrically connected with the balanced current lamp modules 51 and 52. The sub-1-stage balanced transformer 55 is electrically connected with two of the balanced current lamp modules. The other sub-1-stage balanced transformers are electrically connected with two of the balanced current lamp modules.

The sub-2-stage balanced transformer 56 is electrically connected with the sub-1-stage balanced transformers 54 and 55. The other sub-2-stage balanced transformers are electrically connected with two of the sub-1-stage balanced transformers. The connection method is made in the similar manner. Thus, the sub-N-stage balanced transformer 59 is electrically connected with two of the sub-(N-1)-stage balanced transformers 57 and 58, wherein N is a natural number. Consequently, when the multi-lamp is arranged, the working current of each lamp can be balanced and unified according to a plurality of stages of balanced transformers, such that the luminance of each lamp can be unified.

In addition, the sub-N-stage balanced transformer 59 may be electrically connected with a feedback circuit 502, which can control the power source 501 in a feedback manner according to a current flowing through the sub-N-stage balanced transformer 59 so as to adjust the working currents of the lamps in the balanced current lamp modules 51 to 53.

In summary, due to one coil of the transformer of each balanced current unit is electrically connected between two lamps in series, and two coils of the balanced transformer are respectively electrically connected with one of the balanced current units, the working currents of the lamps within each balanced current unit are the same. Comparing with the prior art, a balanced current lamp module and a multi-lamp circuit according to the present invention can decrease the amount and cost of the balanced transformers, and ensure each lamp to have the same luminance.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A balanced current lamp module driven by a power source, the lamp module comprising:
a first balanced current unit comprising a first transformer, a first lamp and a second lamp, wherein the first transformer has one coil electrically connected with the power source and the other coil having two ends respectively electrically connected with the first lamp and the second lamp;
a second balanced current unit comprising a second transformer, a third lamp and a fourth lamp, wherein the second transformer has one coil electrically connected with the power source, and the other coil having two ends respectively electrically connected with the third lamp and the fourth lamp; and
a balanced transformer having one coil electrically connected with the first lamp, and the other coil electrically connected with the fourth lamp.

2. The balanced current lamp module according to claim 1, wherein the first lamp, the second lamp, the third lamp or the fourth lamp is a cold cathode fluorescent lamp.

3. The balanced current lamp module according to claim 1, wherein the first balanced current unit further comprises a first capacitor, which is connected in parallel with the other coil of the first transformer and connected between the first lamp and the second lamp.

4. The balanced current lamp module according to claim 1, wherein the second balanced current unit further comprises a second capacitor, which is connected in parallel with the other coil of the second transformer and connected between the third lamp and the fourth lamp.

5. The balanced current lamp module according to claim 1, wherein the second lamp or the fourth lamp is connected with a resistor in series.

6. The balanced current lamp module according to claim 5, wherein the resistor is a fixed resistor, a positive temperature thermistor or a negative temperature thermistor.

7. The balanced current lamp module according to claim 1, wherein the one coil of the balanced transformer is electrically connected with a feedback control module.

8. A multi-lamp circuit electrically connected with a power source, comprising:
a plurality of balanced current lamp modules, each of which comprises a first transformer, a second transformer, a first lamp, a second lamp, a third lamp, a fourth lamp and a balanced transformer, wherein one coil of the first transformer and one coil of the second transformer are electrically connected with the power source, two ends of the other coil of the first transformer are respectively electrically connected with the first lamp and the second lamp, two ends of the other coil of the second transformer are respectively electrically connected with the third lamp and the fourth lamp, one coil of the balanced transformer is electrically connected with the first lamp, and the other coil of the balanced transformer is electrically connected with the fourth lamp.

9. The multi-lamp circuit according to claim 8, wherein the first lamp, the second lamp, the third lamp or the fourth lamp is a cold cathode fluorescent lamp.

10. The multi-lamp circuit according to claim 8, wherein the balanced current lamp unit further comprises a first capacitor and a second capacitor, the first capacitor is connected in parallel with the other coil of the first transformer and connected between the first lamp and the second lamp, and the second capacitor is connected in parallel with the other coil of the second transformer and connected between the third lamp and the fourth lamp.

11. The multi-lamp circuit according to claim 8, wherein the second lamp or the fourth lamp is connected with a resistor in series.

12. The multi-lamp circuit according to claim 11, wherein the resistor is a fixed resistor, a positive temperature thermistor or a negative temperature thermistor.

13. The multi-lamp circuit according to claim 8, further comprising:
at least one sub-1-stage balanced transformer having two coils respectively electrically connected with two of the balanced current lamp modules.

14. The multi-lamp circuit according to claim 13, wherein one coil of the sub-1-stage balanced transformer is electrically connected with a feedback control module.

15. The multi-lamp circuit according to claim 13, further comprising:
at least one sub-N-stage balanced transformer having two coils respectively electrically connected with two of the sub-(N−1)-stage balanced transformers.

16. The multi-lamp circuit according to claim 15, wherein one coil of the sub-N-stage balanced transformer is electrically connected with a feedback control module.

17. A multi-lamp circuit electrically connected with a power source, comprising:
a plurality of balanced current lamp modules, each of which comprises a first transformer, a second transformer, a first lamp, a second lamp, a third lamp, a fourth lamp and a balanced transformer, wherein one coil of the first transformer and one coil of the second transformer are electrically connected with the power source, two ends of the other coil of the first transformer are respectively electrically connected with the first lamp and the second lamp, two ends of the other coil of the second transformer are respectively electrically connected with the third lamp and the fourth lamp, one coil of the balanced transformer is electrically connected with the first lamp, and the other coil of the balanced transformer is electrically connected with the fourth lamp; and
a plurality of sub-stage balanced transformers, the sub-1-stage balanced transformer is electrically connected with two of the balanced current lamp modules, wherein the sub-N-stage balanced transformer is electrically connected with two of the sub-(N−1)-stage balanced transformers.

18. The multi-lamp circuit according to claim 17, wherein the first lamp, the second lamp, the third lamp or the fourth lamp is a cold cathode fluorescent lamp.

19. The multi-lamp circuit according to claim 17, wherein the balanced current lamp unit further comprises a first capacitor and a second capacitor, the first capacitor is connected in parallel with the other coil of the first transformer and connected between the first lamp and the second lamp, and the second capacitor is connected in parallel with the other coil of the second transformer and connected between the third lamp and the fourth lamp.

20. The multi-lamp circuit according to claim 17, wherein one coil of the sub-N-stage balanced transformer is electrically connected with a feedback control module.
